(19) United States
(12) Patent Application Publication
(10) Pub. No.: US 2012/0158897 A1
(43) Pub. Date: Jun. 21, 2012

(54) SYSTEM AND METHOD FOR INTERACTIVE MULTIMEDIA PRODUCTS PLATFORM

(75) Inventor: Venkatesh M. Sundaram, Flower Mound, TX (US)

(73) Assignee: IYER HOLDINGS, INC., Flower Mound, TX (US)

(21) Appl. No.: 13/311,359

(22) Filed: Dec. 5, 2011

Related U.S. Application Data
(60) Provisional application No. 61/423,446, filed on Dec. 15, 2010.

(51) Int. Cl. G06F 15/16

(52) U.S. Cl. 709/217

(57) ABSTRACT

According to one aspect of the present disclosure, a system, method and technique for an interactive multimedia products platform is disclosed. The system includes: a first unit attachable to an appliance and configured to detect a change in at least one parameter associated with the appliance; and a second unit configured to receive in real time sensor data from the first unit corresponding to the detected parameter and transmit the sensor data in real time over a network to a content provider, the second unit configured to receive multimedia content from the content provider in real time and display the multimedia content in real time on a display device, the multimedia content received from the content provider responsive to the transmitted sensor data.

### BACKGROUND

Consumers use a variety of different mediums for entertainment, such as television, computers, the Internet, etc. These devices are oftentimes used to display audio and/or video content for entertainment and/or educational purposes.

### BRIEF SUMMARY

According to one aspect of the present disclosure a system, method and technique for an interactive multimedia products platform is disclosed. The system includes: a first unit attachable to an appliance and configured to detect a change in at least one parameter associated with the appliance; and a second unit configured to receive in real time sensor data from the first unit corresponding to the detected parameter and transmit the sensor data in real time over a network to a content provider, the second unit configured to receive multimedia content from the content provider in real time and display the multimedia content in real time on a display device, the multimedia content received from the content provider responsive to the transmitted sensor data.

### BRIEF DESCRIPTION OF THE SEVERAL VIEWS OF THE DRAWINGS

For a more complete understanding of the present application, the objects and advantages thereof, reference is now made to the following descriptions taken in conjunction with the accompanying drawings, in which:

FIG. 1 is an embodiment of a network of data processing systems in which the illustrative embodiments of the present disclosure may be implemented;

FIG. 2 is an embodiment of a data processing system in which the illustrative embodiments of the present disclosure may be implemented;

FIG. 3 is a diagram illustrating an embodiment of a data processing system for an interactive multimedia products platform in which illustrative embodiments of the present disclosure may be implemented;

FIG. 4 is a diagram illustrating an embodiment of a remote unit of the interactive multimedia products platform of FIG. 3;

FIG. 5 is a diagram illustrating another embodiment of a remote unit of the interactive multimedia product platform of FIG. 3; and

FIG. 6 is a flow diagram illustrating an embodiment of a method for interactive multimedia product platform processing according to the present disclosure.

### DETAILED DESCRIPTION

Embodiments of the present disclosure provide a method, system and computer program product for an interactive multimedia products platform. For example, in some embodiments, the system and technique includes: a first unit attachable to an appliance and configured to detect a change in at least one parameter associated with the appliance; and a second unit configured to receive in real time sensor data from the first unit corresponding to the detected parameter and transmit the sensor data in real time over a network to a content provider, the second unit configured to receive multimedia content from the content provider in real time and display the multimedia content in real time on a display device, the multimedia content received from the content provider responsive to the transmitted sensor data. Embodiments of the present disclosure enable a real time multimedia experience corresponding to a product or appliance being interacted with by a user by tailoring multimedia content delivered to the user based on information gathered proximate to the user in connection with the appliance.

As will be appreciated by one skilled in the art, aspects of the present disclosure may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present disclosure may take the form of a computer program product embodied in one or more computer readable medium(s) having computer readable program code embodied thereon. Any combination of one or more computer usable or computer readable medium(s) may be utilized. The computer readable medium may be a computer readable signal medium or a computer readable storage medium. A computer readable storage medium may be, for example but not limited to, an electronic, magnetic, optical, electromagnetic, infrared, or semiconductor system, apparatus, or device, or any suitable combination of the foregoing. More specific examples of the computer readable storage medium may include, but not be limited to, an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described below with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

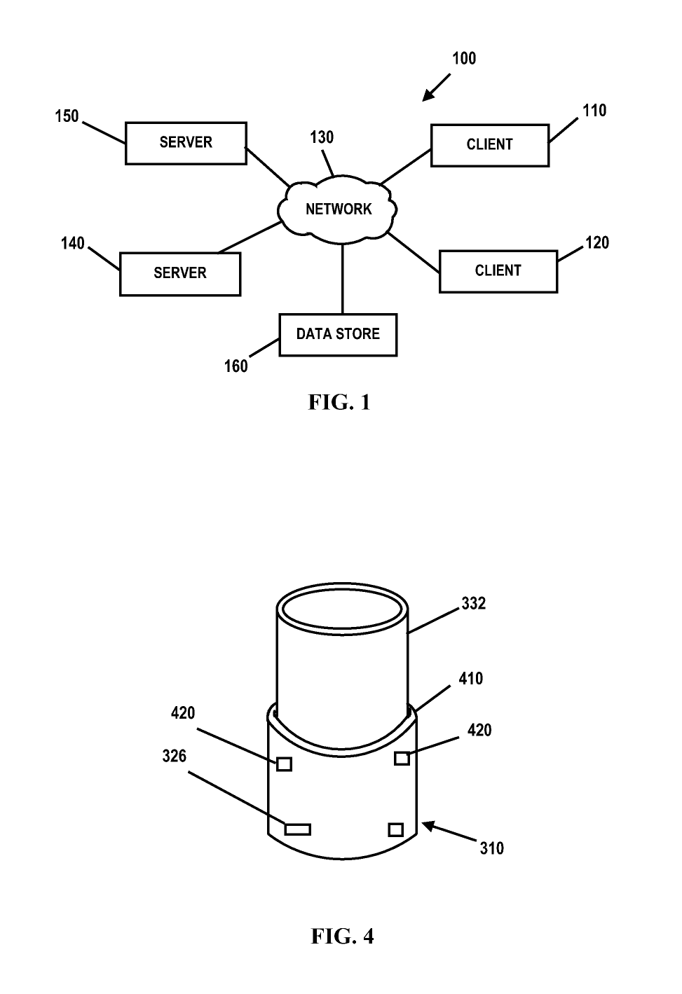

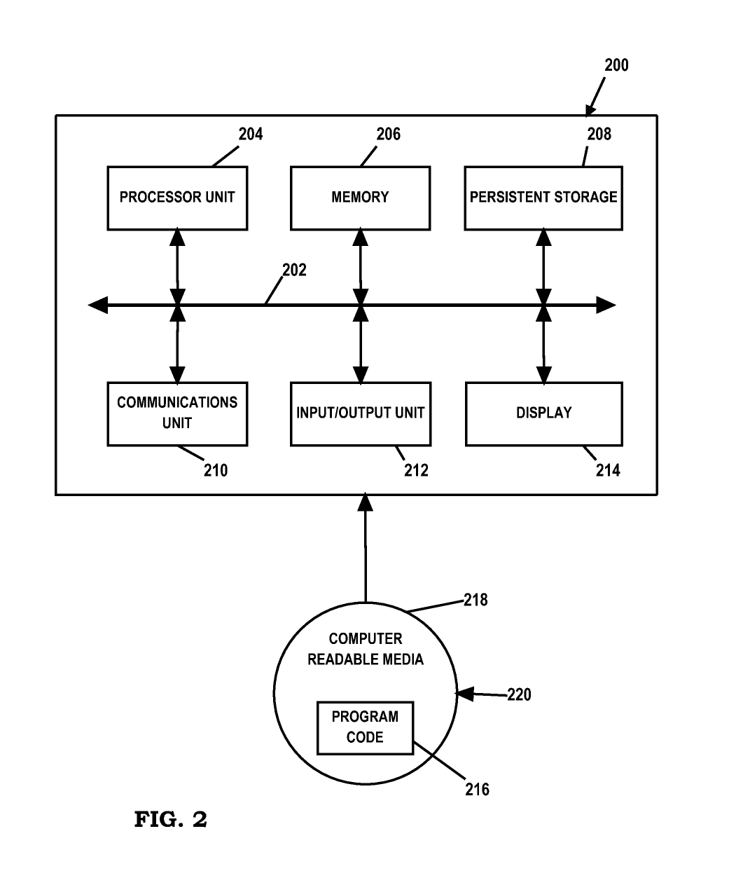

With reference now to the Figures and in particular with reference to FIGS. 1-2, exemplary diagrams of data processing environments are provided in which illustrative embodiments of the present disclosure may be implemented. It should be appreciated that FIGS. 1-2 are only exemplary and are not intended to assert or imply any limitation with regard to the environments in which different embodiments may be implemented. Many modifications to the depicted environments may be made.

FIG. 1 is a pictorial representation of a network of data processing systems in which illustrative embodiments of the present disclosure may be implemented. Network data processing system 100 is a network of computers in which the illustrative embodiments of the present disclosure may be implemented. Network data processing system 100 contains network 130, which is the medium used to provide communications links between various devices and computers connected together within network data processing system 100. Network 130 may include connections, such as wire, wireless communication links, or fiber optic cables.

In some embodiments, server 140 and server 150 connect to network 130 along with data store 160. In addition, clients 110 and 120 connect to network 130. Clients 110 and 120 may be, for example, personal computers, network computers or other types of personal computing devices (e.g., smartphones, personal digital assistants, etc.). In the depicted example, servers 140 and/or 150 provide data and/or services such as, but not limited to, data files, operating system images, and applications to clients 110 and 120. Network data processing system 100 may include additional servers, clients, and other devices.

In the depicted example, network data processing system 100 is the Internet with network 130 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

FIG. 2 is an embodiment of a data processing system 200 such as, but not limited to, client 110 and/or server 140 in which an embodiment of an interactive multimedia products platform system according to the present disclosure may be implemented. In this embodiment, data processing system 200 includes a bus or communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

In some embodiments, memory 206 may be a random access memory or any other suitable volatile or non-volatile storage device. Persistent storage 208 may take various forms depending on the particular implementation. For example, persistent storage 208 may contain one or more components or devices. Persistent storage 208 may be a hard drive, a flash memory, a rewritable optical disk, a rewritable magnetic tape, or some combination of the above. The media used by persistent storage 208 also may be removable such as, but not limited to, a removable hard drive.

Communications unit 210 provides for communications with other data processing systems or devices. In these examples, communications unit 210 is a network interface card. Modems, cable modem and Ethernet cards are just a few of the currently available types of network interface adapters. Communications unit 210 may provide communications through the use of either or both physical and wireless communications links.

Input/output unit 212 enables input and output of data with other devices that may be connected to data processing system 200. In some embodiments, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer readable media 218 may not be removable. Alternatively, program code 216 may be transferred to data processing system 200 from computer readable media 218 through a communications link to communications unit 210 and/or through a connection to input/output unit 212. The communications link and/or the connection may be physical or wireless in the illustrative examples.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown. For example, a storage device in data processing system 200 is any hardware apparatus that may store data. Memory 206, persistent storage 208, and computer readable media 218 are examples of storage devices in a tangible form.

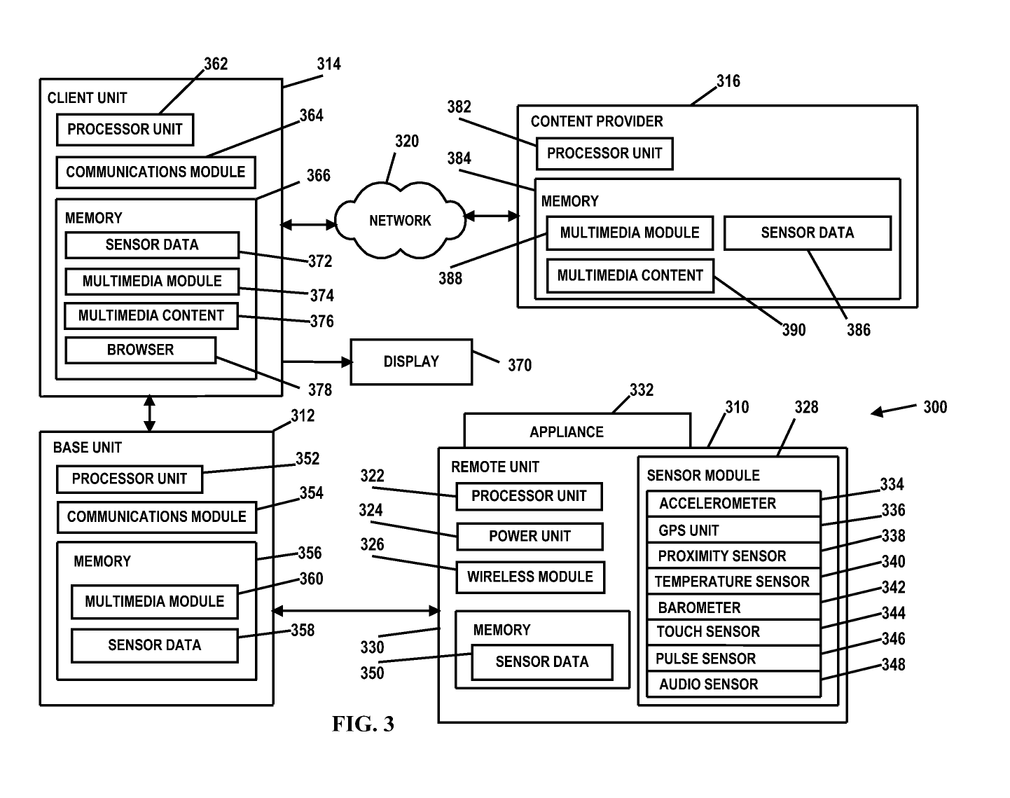

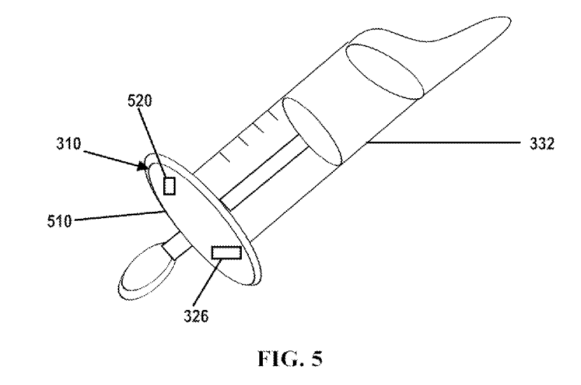

FIG. 3 is an illustrative embodiment of an interactive multimedia products platform system 300 in accordance with the present disclosure. System 300 may be implemented on data processing systems or platforms such as, but not limited to, client 110, server 140 or at other data processing system locations. In FIG. 3, system 300 includes a remote unit 310, a base unit 312, a client unit 314 and a multimedia content provider 316. Various components of system 300 may communicate with each other over wired and/or wireless networks, such as network 320. Network 320 may comprise the Internet or another type of communications network.

In the embodiment illustrated in FIG. 3, remote unit 310 includes a processor unit 322, a power unit 324, a wireless communications module 326 a sensor module 328 and a memory 330. In general, processor unit 322 processes and/or executes instructions (e.g., software code) and performs logic functions and/or calculations while memory 330 temporarily or permanently stores information that may be retrieved therefrom. Remote unit 310 is configured to be attached to an appliance 332 (e.g., releasably secured thereto to enable attachment thereto and detachment therefrom). Appliance 332 may be any type of product or device that a user may interact with and/or otherwise manipulate such as, but not limited to, a toy, an eating or food-related device (e.g., a dish, glass, saucer, cup, bottle or utensil), a medicine dispenser, a tool, etc. It should also be understood that in some embodiments, remote unit 310 may be incorporated into and/or otherwise form part of appliance 332 (e.g., constructed as a single or integral unit). Power unit 324 may be any type of device for independently powering remote unit 310 (e.g., a rechargeable or non-rechargeable battery). Wireless communications module 326 may comprise an antenna, transceiver and/or other hardware, software and circuitry to enable various types of data to be communicated between remote unit 310 and other devices of system 300. For example, in some embodiments, module 326 enables data to be wirelessly communicated from remote unit 310 to base unit 312.

Sensor module 328 is configured to detect one or more different types of sensor inputs related to appliance 332. For example, in some embodiments, sensor module 328 includes an accelerometer 334, a geopositional unit 336, a proximity sensor 338, a temperature sensor 340, a barometric pressure sensor 342, a touch sensor 344, a pulse sensor 346 and an audio sensor 348. It should be understood that the quantity and/or types of sensors included in sensor module 328 may vary. Thus, in the illustrated embodiment, sensor module 328 may be configured to detect changes in position and/or movement of appliance 332, a location of appliance 332 relative to a user or other object, a temperature of an area surrounding appliance 332 or of a user interacting with appliance 332, the barometric pressure surrounding appliance 332, whether a user is touching or in contact with appliance 332, a pulse rate of a user interacting with appliance 332 and/or audio input from a user interacting with appliance 332 (e.g., voice commands or vocal input). In FIG. 3, memory 330 includes sensor data 350 comprising information associated with the different types of sensor inputs detected by sensor module 328.

In the embodiment illustrated in FIG. 3, base unit 312 includes a processor unit 352, a communications module 354 and a memory 356. In general, processor unit 352 processes and/or executes instructions (e.g., software code) and performs logic functions and/or calculations while memory 356 temporarily or permanently stores information that may be retrieved therefrom. Communications module 354 enables wired and/or wireless communication of data between base unit 312 and other devices of system 300. For example, communications module 354 may comprise an antenna, transceiver and/or other hardware, software and circuitry to enable various types of data to be communicated between base unit 312 and client unit 314, between base unit 312 and remote unit 310, and/or between base unit 312 and content provider 316. In some embodiments, base unit 312 comprises a stand-alone device that may be connected to client unit 314 to facilitate data communications therebetween. Base unit 314 may be independently powered (e.g., via an alternating current (AC) or direct current (DC) power supply) or may receive operating power from client unit 314.

In FIG. 3, memory 356 includes sensor data 358 and a multimedia module 360. Sensor data 358 may comprise sensor data detected by and received from remote unit 310 (e.g., sensor data 350). Multimedia module 360 may be used to process and/or perform various function related to sensor data 358. For example, multimedia module 360 may be implemented in any suitable manner that may be hardware-based, software-based, or some combination of both. For example, module 360 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system). In some embodiments, module 360 is software (e.g., a set of instructions and/or an algorithm) that, when executed by processor unit 352, processes sensor data 358 and communicates sensor data 358 to client unit 314.

In the embodiment illustrated in FIG. 3, client unit 314 includes a processor unit 362, a communications module 364, and a memory 366. In general, processor unit 362 processes and/or executes instructions (e.g., software code) and performs logic functions and/or calculations while memory 366 temporarily or permanently stores information that may be retrieved therefrom. Communications module 364 enables wired and/or wireless communication of data between client unit 314 and other devices of system 300. For example, communications module 364 may comprise an antenna, transceiver and/or other hardware, software and circuitry to enable various types of data to be communicated between client unit 314 and base unit 312, between client unit 314 and content provider 316, and/or between client unit 314 and a display device 370. Client unit 314 may comprise any type of computing device such as, but not limited to, a personal computer, smartphone, tablet computer, laptop computer, desktop computer, etc.

In FIG. 3, memory 366 includes sensor data 372, a multimedia module 374, multimedia content 376 and a browser 378. Sensor data 372 may comprise sensor data detected by remote unit 310 (e.g., via sensor module 328) and received from base unit 312 (e.g., sensor data 358) and/or remote unit 310 (e.g., sensor data 350). Multimedia content 376 includes multimedia information (e.g., audio and/or video content) received from content provider 316 and displayed by client unit 314 on display device 370. Multimedia module 374 may be used to process and/or perform various function related to sensor data 372 and/or multimedia content 376. Browser 378 may be used to access various web-based computer resources. For example, browser 378 may include a web browser for locating, requesting, retrieving and displaying computer resources in the form of static or dynamic web pages or server-provided content. Multimedia module 374 and/or browser may be implemented in any suitable manner that may be hardware-based, software-based, or some combination of both. For example, module 374 and/or browser 378 may comprise software, logic and/or executable code for performing various functions as described herein (e.g., residing as software and/or an algorithm running on a processor unit, hardware logic residing in a processor or other type of logic chip, centralized in a single integrated circuit or distributed among different chips in a data processing system). In some embodiments, module 374 and/or browser 378 are software (e.g., a set of instructions and/or an algorithm) that, when executed by processor unit 362, perform various functions as described herein.

In the embodiment illustrated in FIG. 3, content provider 316 includes a processor unit 382 and a memory 384. In general, processor unit 382 processes and/or executes instructions (e.g., software code) and performs logic functions and/or calculations while memory 384 temporarily or permanently stores information that may be retrieved therefrom. In some embodiments, content provider 316 comprises a web server or other type of web-based data processing resource accessible by client unit 314 via network 320.

In FIG. 3, memory 384 includes sensor data 386, a multimedia module 388 and multimedia content 390. Sensor data 386 may comprise sensor data detected by remote unit 310 (e.g., via sensor module 328) and received from client unit 314 (e.g., sensor data 372) and/or base unit 312 (e.g., sensor data 358). Multimedia content 390 includes multimedia information (e.g., audio and/or video content) in the form of static images, streaming audio/video content or other types of audio/visual content. Multimedia module 388 may be used to process and/or perform various function related to sensor data 386 and/or multimedia content 390. For example, in some embodiments, based on sensor data 386 received by content provider 316 as detected by sensor module 328, multimedia module 388 selects, modifies and/or otherwise configures multimedia content 390 based on sensor data 386.

In operation, client unit 314 is used to log onto and/or otherwise access content provider 316 via network 320 (e.g., using browser 378 or otherwise). Content provider 316 provides multimedia content 390 over network 320 to client unit 314 which client unit 314 thereafter displays on display device 370. Client unit 314 and/or content provider 316 may be configured to enable a user to select various types of titles, content or programs (e.g., a learning or educational program, a game program, a do-it-yourself video, etc.). Various types of sensor information gathered and/or otherwise accumulated by remote unit 310 (e.g., via sensor module 328) is communicated to content provider 316. For example, in some embodiments, sensor data 350 acquired by remote unit 310 is wirelessly communicated to base unit 312 (which may be temporarily stored by base unit 312 as sensor data 358) and is thereafter communicated to client unit 314 (which may be temporarily stored by client unit 314 as sensor data 372) and then to content provider 316. In some embodiments, the various types of sensor inputs acquired by sensor module 328 are communicated to content provider 316 in real time (e.g., without appreciable and/or noticeable delay), thereby facilitating dynamic real time responsiveness to the sensor data 350 by content provider 316.

Multimedia module 388 of content provider 316 receives the various types of sensor inputs collected/detected by sensor module 328 and dynamically selects, modifies and/or updates multimedia content 390 provided to client unit 314 for display on display device 370 that is responsive to such sensor inputs. As an illustrative example, appliance 332 may comprise a tea cup, and multimedia content 390 may comprise an interactive tea party for a child such that the child's use and manipulation of the tea cup appliance 332 by the child user is detected by sensor module 328 and communicated to content provider 316. In this example, characters depicted in the multimedia content 390 may request that the child user of the tea cup appliance 332 move the tea cup appliance 332 forward to enact the make-believe activity of pouring tea into the tea cup appliance 332. Accelerometer 334, geopositional unit 336 and/or other sensor units of sensor module 328 detect a change in various aspects related to the tea cup appliance 332 and such detected sensor inputs are communicated to content provider 316. In response to receiving and/or analyzing sensor data 386 corresponding to the tea cup appliance 332 as detected by sensor module 328, multimedia module 388 may automatically (e.g., without user intervention) modify and/or select a next segment of multimedia content 390 based on sensor data 386 (e.g., thanking the child user for presenting the tea cup appliance 332, requesting that the child user move the tea cup appliance 332 closer to the table, etc.). Multimedia module 388 may be configured to respond to audio input received by an audio sensor 348 of sensor module 328, detect whether the child user is holding the tea cup appliance 332 (e.g., via touch sensor 344 and/or temperature sensor 340) and/or respond to various movements of the tea cup appliance 332 (e.g., via accelerometer 336, proximity sensor 338 and/or geopositional unit 336).

In some embodiments, multimedia module 388 may monitor multimedia content 390 (e.g., using markers, frame identifiers, or other means) to identify various stimuli or queries presented to a viewing user interacting with appliance 332 in such multimedia content 390 (e.g., displayed and/or presented to a user of appliance 332 on display device 370). Multimedia module 390 may be configured to proceed or progress to certain segments and/or frames of multimedia content 390 based on a response from the user of appliance 332 as detected by sensor module 328 and analyzed by multimedia module 388. However, it should be understood that other methods may be used to analyze sensor data 386 and/or determine the modification and/or selection of multimedia content 390 based on the sensor data 386.

It should be understood that various components of system 300 may be combined and/or otherwise distributed than that shown in FIG. 3. For example, in some embodiments, one or more functions of base unit 312 may be incorporated into and/or be an integral part of client unit 314 (e.g., remote unit 310 may communicate sensor data 350 directly to client unit 314). In some embodiments, base unit 312 may be configured to transmit sensor data 358 directly to content provider 316. In some embodiments, base unit 312 may be configured as an adapter or portable device that may be plugged into and/or otherwise connected to client unit 314.

FIG. 4 is a diagram illustrating an embodiment of remote unit 310 in accordance with an embodiment of the present disclosure. In this embodiment, remote unit 310 is attached to appliance 332 in the form of a cup. In the embodiment illustrated in FIG. 4, remote unit 310 comprises a sleeve 410 having one or more sensors 420 attached thereto and/or embedded therein (e.g., accelerometer 334, temperature sensor 340, etc.). Sleeve 410 may be configured to slide over at least a portion of cup appliance 332 such that various parameters associated with cup appliance 332 may be measured and/or detected. Sleeve 410 also includes wireless module 326 to wirelessly transmit sensor data 350 from remote unit 310 to base unit 312 and/or client unit 314. Thus, in operation, various types of different parameters may be measured and/or detected by remote unit 310 in relation to cup appliance 332 and communicated to content provider 316 (e.g., via base unit 312 and/or client unit 314). In response to receiving and analyzing the sensor data 350 acquired by remote unit 310, content provider 316 selects and/or modifies the multimedia content 390 presented for display on display 370 based on the detected parameters.

FIG. 5 is a diagram illustrating another embodiment of remote unit 310 in accordance with the present disclosure. In this embodiment, remote unit 310 is attached to appliance 332 in the form of a medicine dispenser. In the embodiment illustrated in FIG. 5, remote unit 310 comprises a circular disk-shaped unit 510 having one or more sensors 520 attached thereto and/or embedded therein (e.g., accelerometer 334, temperature sensor 340, etc.). Unit 510 also includes wireless module 326 to wirelessly transmit sensor data 350 from remote unit 310 to base unit 312 and/or client unit 314. It should be understood that remote unit 310 may be constructed with apertures, clips, hooks, fasteners, or other elements to facilitate attachment of remote unit 310 to a variety of different types of appliances 332.

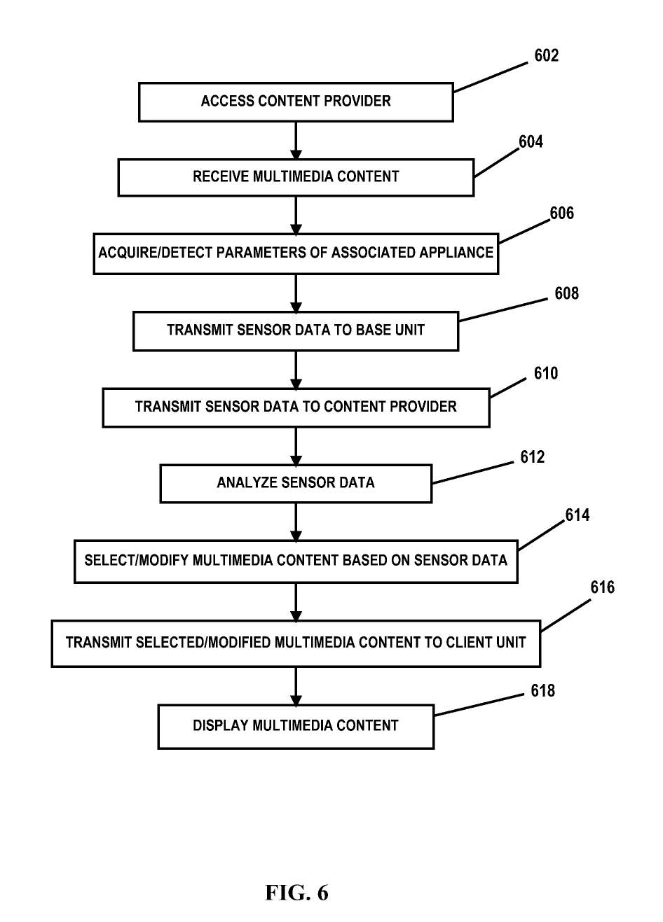

FIG. 6 is a flow diagram illustrating an embodiment of an interactive multimedia products platform method. The method begins at block 602, where content provider 316 is accessed (e.g., via client unit 314). At block 604, multimedia content is received from content provider 316 and displayed on display 370. At block 606, remote unit 310 acquires and/or otherwise detects various parameters associated with a corresponding appliance 332 (e.g., via sensor module 328). The detected parameters may relate to appliance 332 itself or a user interacting with appliance 332. At block 608, sensor data 350 acquired by remote unit 310 is communicated to base unit 312. At block 610, sensor data 350 acquired by remote unit 310 is transmitted to content provider 316 (e.g., by base unit 312 and/or client unit 314).

At block 612, multimedia module 388 of content provider 316 analyzes the sensor data gathered by remote unit 310. At block 614, multimedia module 388 selects and/or otherwise modifies multimedia content to be transmitted to client unit 314 based on the sensor data acquired and transmitted by remote unit 310. At block 616, content provider 316 transmits the selected/modified multimedia content to client unit 314. At block 618, client unit 314 displays the received multimedia content on display 370.

Thus, embodiments of the present disclosure enable interactive multimedia content to be delivered to a user that is responsive to real time inputs associated with an appliance being interacted with by the user. Various types of sensor inputs are detected by a remote unit corresponding to the appliance and transmitted in real time over a network (such as the Internet) to a content provider, thereby enabling the content provider to modify and/or select the multimedia content delivered to the user based on the received sensor input data.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. An interactive multimedia products plat form system, comprising:
a first unit attachable to an appliance and configured to detect a change in at least one parameter associated with the appliance;
a second unit configured to receive in real time sensor data from the first unit corresponding to the detected parameter and transmit the sensor data in real time over a network to a content provider, the second unit configured to receive multimedia content from the content provider in real time and display the multimedia content in real time on a display device, the multimedia content received from the content provider responsive to the transmitted sensor data.

2. The system of claim 1, wherein the first unit is configured to wirelessly transmit the sensor data to the second unit.

3. The system of claim 1, wherein the first unit is configured to detect at least one of a temperature input, an audio input, an acceleration input, and a geopositional input.

4. The system of claim 1, wherein the first unit comprises a sensor module configured to detect a plurality of different types of sensor inputs.

5. The system of claim 1, wherein the first unit is configured to be attachable to an eating appliance.

6. The system of claim 1, wherein the first unit comprises a sleeve operable to slide over at least a portion of the appliance.

7. The system of claim 1, wherein the first unit is attachable to a medicine dispenser.

8. An interactive multimedia products platform method, comprising:
broadcasting multimedia content over a network to a client system, the multimedia content related to an appliance interacted with by a user of the client system experiencing the multimedia content;
receiving from the client system real time sensor data associated with the appliance, the sensor data corresponding to at least one sensor input detected in real time corresponding to the appliance; and
broadcasting modified multimedia content related to the appliance in real time to the client system based on the sensor data.

9. The method of claim 8, wherein receiving the sensor data comprises receiving at least one of a temperature input, an audio input, an acceleration input, and a geopositional input.

10. The method of claim 8, wherein broadcasting the modified multimedia content comprises modifying the multimedia content based on a plurality of different types of sensor inputs corresponding to the appliance.

11. An interactive multimedia products platform system, comprising:
a first unit configured to detect a change in at least one parameter associated with an appliance; and
a second unit comprising:
a processor; and
a multimedia module executable by the processor to:
communicate over a network with a multimedia content provider;
receive sensor data from the first unit corresponding to the detected parameter and transmit the sensor data to the multimedia content provider; and
receive multimedia content from the multimedia content provider and display the multimedia content on a display device, the multimedia content received from the multimedia content provider responsive to the transmitted sensor data.

12. The system of claim 11, wherein the first unit is configured to wirelessly transmit the sensor data to the second unit.

13. The system of claim 11, wherein the first unit is configured to detect at least one of a temperature input, an audio input, an acceleration input, and a geopositional input.

14. The system of claim 11, wherein the first unit comprises a sensor module configured to detect a plurality of different types of sensor inputs.

15. The system of claim 11, wherein the first unit is configured to be attachable and detachable relative to the appliance.

16. The system of claim 11, wherein the first unit comprises a sleeve operable to slide over at least a portion of the appliance.

17. The system of claim 11, wherein the first unit is attachable to a medicine dispenser.

18. The system of claim 11, wherein the first unit is configured to be attachable to an eating appliance.
